(19) United States
(12) Patent Application Publication
(10) Pub. No.: US 2005/0125590 A1
(43) Pub. Date: Jun. 9, 2005

(54) PCI express switch

(76) Inventors: Stephen H. Li, Plano, TX (US); Brian Tse Deng, Richardson, TX (US); Paul Howard, Richardson, TX (US); Dave Kimble, Carrollton, TX (US)

Correspondence Address: TEXAS INSTRUMENTS INCORPORATED, P O BOX 655474, M/S 3999, DALLAS, TX, 75265, US

(21) Appl. No.: 10/731,743

(22) Filed: Dec. 9, 2003

(51) Int. Cl. G06F 13/00

(52) U.S. Cl. 710/317

(57) ABSTRACT

A PCI Express switch utilizes a central crossbar memory for all ports of the switch. The crossbar memory retains the packet that is to be sent out and only the head pointer for the packet is transmitted to the transmission port. The crossbar memory can also be used as the replay memory for the switch. A circuit for choosing the head pointer at a port for the packet to be sent out, is also disclosed.

### REFERENCE TO RELATED APPLICATIONS

This application is related to U.S. application Ser. No. ______ (TI-36016) filed on even date and, entitled “A Weighted-Round Robin Arbitrator”, which is incorporated herein by reference.

### FIELD OF THE INVENTION

This invention relates to a network switch and more specifically to a network switch for a PCI Express fabric.

### BACKGROUND OF THE INVENTION

Peripheral Component Interconnect (PCI) is a parallel bus architecture developed in 1992 which has become the predominant local bus for personal computers and similar platforms. The implementation of this technology has come close to its practical limits of performance and can not easily be scaled up in frequency or down in voltage. A new architecture utilizing point-to-point transmission, having a higher speed, and which is scalable for future improvements, is known as PCI Express.

A PCI Express switch receives data from other network components on a PCI Express fabric and routes them along another path within the fabric. Typically this switch will have one or more upstream ports for receiving data from other switches and two or more down stream ports to allow the data to flow in different branches of the fabric. The output port from which a data packet is to be sent may be busy sending other data packets or the next device on the PCI Express fabric to which the data is to be sent may be busy receiving other packets. Accordingly, a PCI Express switch must have a local buffer memory for storing this data until the data path from this switch to the next PCI Express device is available. The data received could be stored utilizing the parameters: the port from which the packet is to be sent, the virtual channel to which it will be assigned or, for device on a PCI bus which shares multiple functions, the function to be performed. However, storing the data in the buffer memory in this manner is very inefficient. This is because, for a given number of packets that need to be stored, the amount of memory space in the buffer memory must be N times the equivalent of the switch's sum total of credits, where N is the number of ports of the switch, because all the data from all ingress ports could go to a single egress port for each egress port. This additional memory increases the size of the integrated circuit chip and therefore the cost thereof as well as reducing the yields from the manufacturing process. Accordingly, there is a need for a buffer memory for a PCI Express fabric switch which can more efficiently store the data packets being transmitted through the switch.

### SUMMARY OF THE INVENTION

It is a first general object of the invention to provide a centralized buffer memory and a second general object to provide an arbitration circuit for an output port for a PCI Express switch.

This and other objects and features are attained in accordance with an aspect of the invention by a PCI Express switch comprising a plurality of ports. A plurality of port controllers, each controller being coupled to one of the ports. A local bus coupling the port controllers to a controller subsystem. A single crossbar memory coupled to each of the port controllers and the controller subsystem, the crossbar memory serving as a common port or virtual channel memory for each of the port controllers.

Another aspect of the invention includes an arbitration circuit for an output port. A FIFO queue contains a head pointer and a plurality of characterizing data for each packet received at an input port, the queue forming a look-up table to determine which data will be sent out from the output port. A plurality of arbitration circuits are coupled to the look-up table for selecting the next packet to be sent out corresponding to a preselected characterizing datum.

### BRIEF DESCRIPTION OF THE DRAWINGS

FIG. 1 is a block diagram of a PCI Express switch according to the present invention;

FIG. 2 illustrates the storage of packets within the crossbar memory of the present invention;

FIG. 3 illustrates the PCI Express packet storage data structure of the present invention;

FIG. 4 is a portion of the crossbar memory controller showing the bank select, port select and write address logic;

FIG. 5 is a portion of the crossbar memory controller showing the memory bank write multiplex logic;

FIG. 6 is portion of the crossbar memory controller showing the port read address logic;

FIG. 7 is portion of the crossbar memory controller showing the memory bank read control logic;

FIG. 8 is a crossbar memory bank access interface signal generator;

FIG. 9 illustrates the port receive packet write timing diagram;

FIG. 10 illustrates the port transmit packet read timing diagram;

FIG. 11 illustrates the port transmit read timing diagram showing read termination;

FIG. 12 illustrates a port/VC arbitration block diagram; and

FIG. 13 illustrates a system for reading the data stored in the table shown in FIG. 12.

### DETAILED DESCRIPTION OF THE PRESENT INVENTION

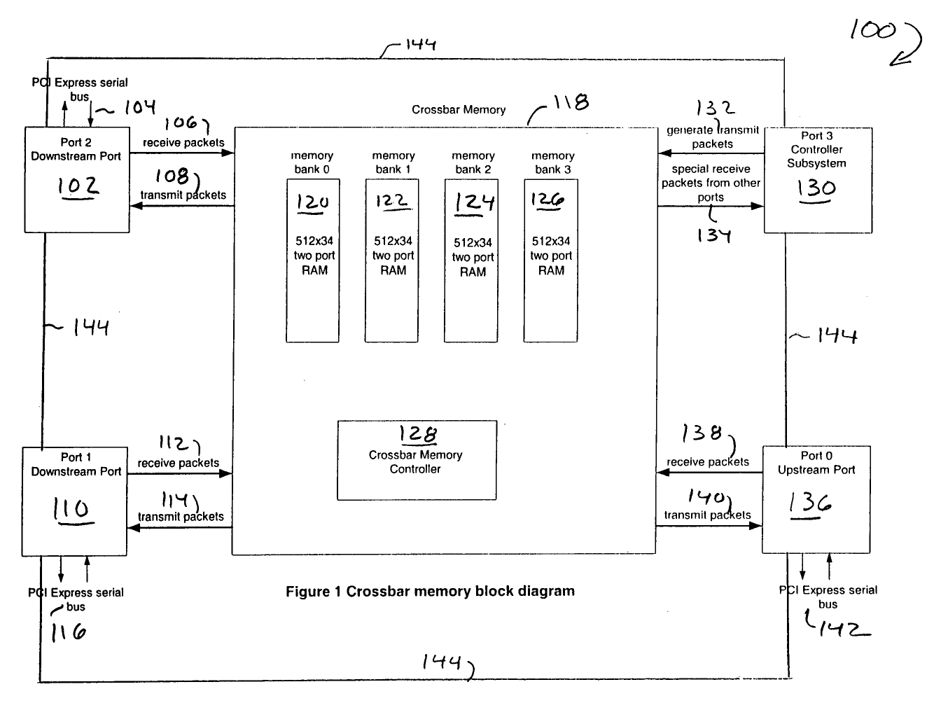

FIG. 1 illustrates a block diagram of a PCI Express switch according to the present invention generally as 100. The PCI Express switch has a port 0 which is the upstream port for transmitting and receiving data from other devices on the PCI Express fabric. The PCI Express switch also has 2 downstream ports, ports 1 and 2, which are coupled via PCI Express serial busses to other devices on the PCI Express fabric. The switch also has a controller subsystem 130 which is virtual port, illustrated as port 3, for the system. The controller subsystem has the intelligence for the switch and would typically contain a microcontroller. The controller subsystem 130 is in communication with the other ports, port 0, port 1 and port 2 via an internal bus 144. This internal bus provides a control path which is utilized by the controller subsystem 130 to set the configuration for the ports 0, 1 and 2 on power up of the system, to check the status of each of the port, to process transactions which terminate within the switch itself, and to generate transactions which originated from the switch itself. For example, the PCI Express switch might receive a packet requesting that a register in one of the ports 0, 1 or 2 be read. The microcontroller subsystem 130 would read that register via the internal control bus 144 and then generate a return packet that is transmitted. This return packet would be sent from the controller subsystem 130 via bus 132 to the crossbar memory 118 and then transmitted as will be described herein below. If the data in the register indicated that an error had occurred, the return packet could be an error packet which would be sent via the upstream port 136 to the CPU of a computer on the PCI Express fabric, to notify the computer that the error has occurred.

Each of the ports 0, 1, 2 and 3 have a two way bus which communicates with a common crossbar memory 118. Ports 0, 1 and 2 have lines 138, 140; 112, 114 and 106, 108 respectively to receive or transmit packets to or from the crossbar memory 118. The crossbar memory 118 serves as a common memory for all the ports for data flowing upstream, downstream, or peer-to-peer on the network and for the transmission of transmit packets generated by the controller subsystem 130. Crossbar memory 118 is divided into four memory banks 0, 1, 2 and 3 illustrated by blocks 120, 122, 124 and 126 respectively. As illustrated each of the memory banks contains 512 34 bit words implemented by a 2 port RAM. A 2 port RAM has a write port and a separate read port. A crossbar memory also has a crossbar memory controller 128 which controls the operation of the crossbar memory 118. It is advantageous to have the crossbar memory divided into a plurality of banks, where the plurality equals the number of ports, or virtual ports in the system. In the present invention, the system has 4 ports, 0, 1, 2, and 3 and thus the memory is divided into 4 memory banks 0, 1, 2 and 3. This will be explained in more detail herein below.

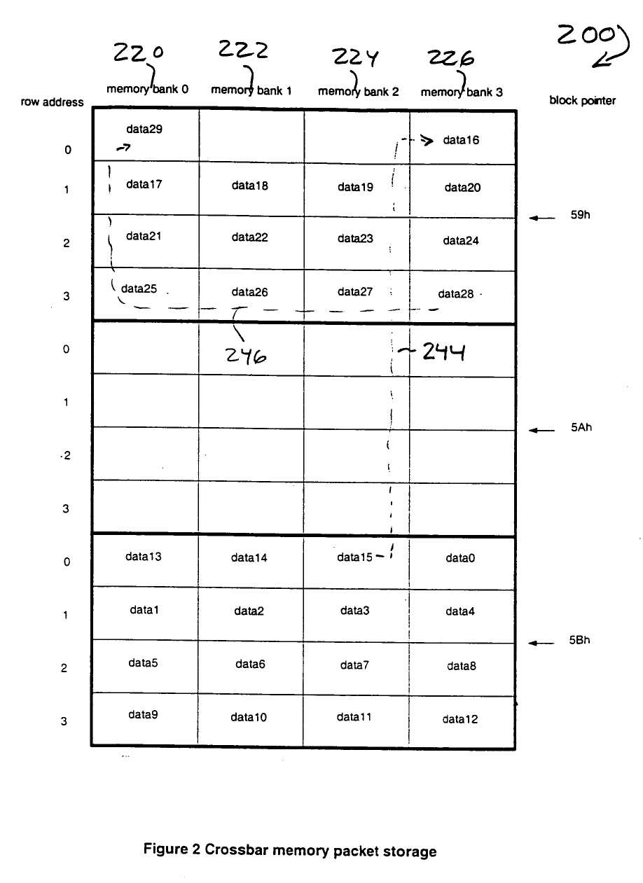

FIG. 2 illustrates how the data is stored within the crossbar memory 118 generally as 200. As discussed above, the memory is divided into 4 memory banks, banks 0, 1, 2 and 3, illustrated by columns 220, 222, 224 and 226. Memory bank 0 120, memory bank 1 122, memory bank 2 124 and memory bank 3 126 are divided into 128 blocks each of which contain 64 bytes. As illustrated, 3 memory blocks 59h, 5Ah and 5Bh are shown in FIG. 2. Each of the 4 memory banks within each of the blocks contains 4 double words, where a double word contains 4 bytes. Thus, a 2 bit row address can be utilized to indicate which of the double words of the specified memory bank in a memory block will be accessed by one of the ports writing data into or reading data from the common crossbar memory. There are a total of 128 memory blocks and thus a 7 bit memory block pointer can be used to specify a memory block number. The 7 bit memory block pointer can be concatenated with a 2 bit row address to form a 9 bit address used to access a memory row location. The 9 bit address can be utilized along with a 2 bit memory bank select number to access a specific memory word.

Each port contains a 2 bit register to indicate which bank the port can access during that clock cycle. A port bank select number is continually rotated as 0, 1, 2, 3, 0, 1, 2, 3 . . . . Thus, each of the ports will be able to access and write to one of the memory banks during any given clock cycle, and thus there is no delay in writing data to the crossbar memory. In the example illustrated in FIG. 2, the first data received from a packet, data 0, is-stored in memory bank 3 of memory bank 5Bh. The second data, data 1, is stored in memory bank 0 in the same memory block, on row address 1. The data that follows will follow a similar sequence, with data 2 appearing in memory bank 1, row address 1, data 3 appearing in memory bank 2, row address 1 and data 4 appearing in memory bank 3, row address 1. The last data to be stored in memory block 5Bh is data 12 which appears in memory bank 3, and row address 3. The next data, data 13, is stored in memory bank 0, row address 0, in the same memory block. Data 14 and data 15 follow this pattern along row address 0 in memory banks 1 and 2, respectively. The next data cannot be placed into memory bank 3, row address 0 because that segment of the memory has already been utilized for data 0. Therefore, data 16 is stored in memory bank 3, but at row address 0 of memory block 59h. This means that data 17 is stored in memory bank 0, row address 1 in the same memory block and data 18, 19 and 20 follow along row address 1. The next 8 data words follow in sequence until data 29 is reached. Data 29 appears in memory bank 0, row address 0 of memory block 59h so that the data remains within the memory block until all of the 4 double word segments have been filled. The paths of the data when the data cannot be written into the next segment within that memory block is illustrates by dotted lines 244 and 246 in FIG. 2.

PCI Express packets are stored in the crossbar memory utilizing a link list data structure. Each memory location contains 34 bits of data. The lower order 32 bits (31:0) are used to store the data packet or end-of-packet status token. Bit 32 is used as an end-of-packet (EOP) token tag. If bit 32 is a 1, bits (31:0) contain the end-of-packet status token. If bit 32 is a 0, bits (31:0) contain the packet data. Bit 33 is used to store the next memory block pointer value for this packet. In this system, instead of looking for a pointer at the beginning or end of a memory block which contains the location of the next value for the link-list data structure, the pointers are stored as a single bit which is read out from a plurality of words to form the pointer. This allows the data to be read out the same way for each segment of the link-list data structure. In this system, all 128 blocks are used, so that the pointer is a 7 bit number. Therefore, only the first 7 words contain a bit used to form the next memory point of value. In the remaining words in the link list data structure, those bits are don't care states and are ignored.

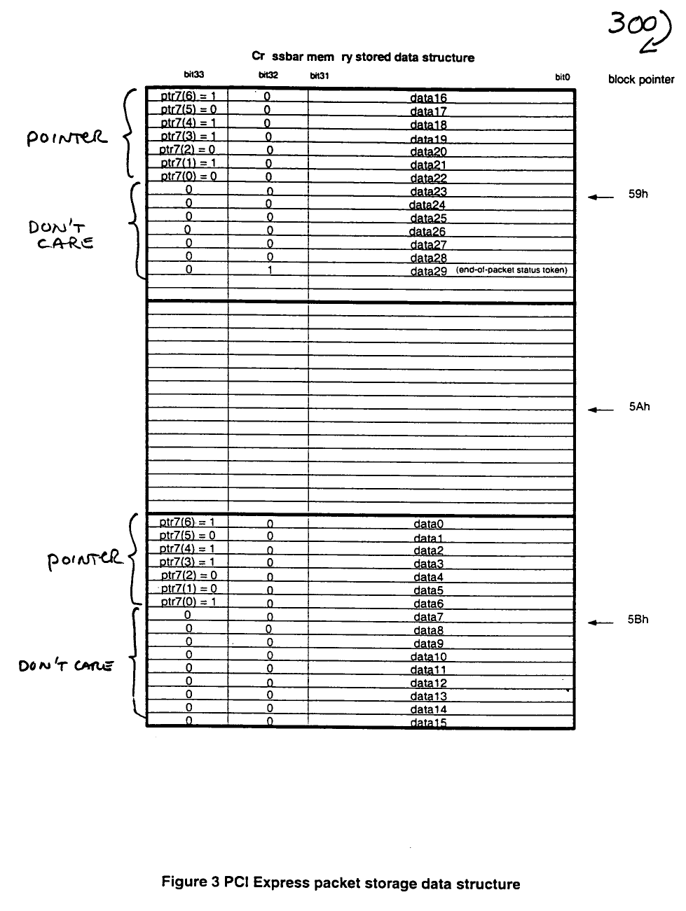

FIG. 3 illustrates a data structure for the example shown in FIG. 2 generally as 300. The first memory block is memory block number 5Bh and its next pointer value is 59h. The bit 33 of the first word contains the pointer “ptr 7 (6)”. The bit 33 of the second word contains the pointer “ptr 7 (5)”. The bit 33 of the third word contains the pointer “ptr 7 (4)”. The bit 33 of the fourth word contains the pointer “ptr 7 (3)”. The bit 33 of the fifth word contains the pointer “ptr 7 (2)”. The bit 33 of the sixth word contains the pointer “ptr 7 (1)”. The bit 33 of the seventh word contains the last bit of the pointer “ptr 7 (0)”. The bits 33 of the remaining words in the memory block 5BH are in the don't care status, as illustrated to the left of the corresponding memory link-list data structure. In memory block number 59h, its next pointer value is 5Ah, which points to the memory block below it. Memory block 59h contains the last memory block, so the next pointer is not utilized in this case. In memory bank 59h, the last word, data 29, contains the end-of-packet status token and bit 32 is set to 1. The end-of-packet status token is not part of a PCI Express packet. It contains the total packet data count (not including the token itself), status information, and error flags.

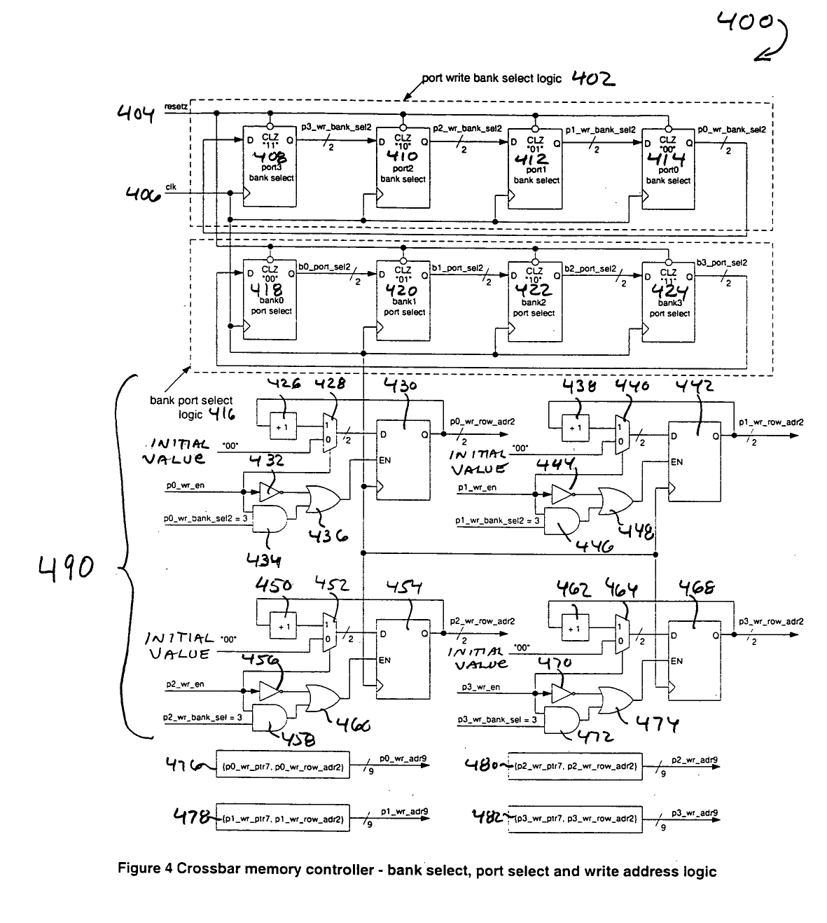

FIG. 4 illustrates the bank select, port select and write address logic for the crossbar memory controller 128, generally as 400. This portion of the crossbar memory controller controls the port memory access, and the memory bank read and write operations. The port write bank select logic 402 is synchronized with the bank port select logic 416. The port write bank select logic is used to assign memory bank numbers to each port at any given clock cycle, so that each port can have a memory bank to access at each cycle and there is no more than one port which can access any memory bank during any given cycle. The band port select logic is used to assign a port number to each memory bank, so that a port can access the memory bank during its current clock cycle.

The port bank select logic 402 comprises four D-type flip flops 408, 410, 412 and 414 which correspond to the port 3 bank select, the port 2 bank select, the port 1 bank select and the port 0 bank select signals, respectively. A clock signal on line 406 is applied to the clock inputs of each of the 4 D-type flip flops The D input to flip flop 408 for port 3 is coupled to the Q output of flip flop 414 for port 0. The Q output of flip flop 408 is coupled to the D input of flip flop 410 for port 2. The Q output of flip flop 410 is coupled to the D input of flip flop 412 for port 1 and the Q output of flip flop 412 is coupled to the D input of flip flop 414 for port 0. Each of the flip flops is coupled to a signal resetz on line 404 which resets the flip flop to its default value on power up reset. The signal p0_wr_bank_sel2 is the bank select signal for port 0 and the default value for the flip flop after power up reset is “00” that is, assigned to memory bank 0. The signal p1_wr_bank_sel2 is the bank signal for port 1 and flip flop 412 is assigned a power up reset default value of “01”, assigned to memory bank 1. The signal p2_wr_bank_sel2 is the bank select signal for port 2 and flip flop 410 has its default value after power up reset of “10”, assigned to memory bank 2. The signal p3_wr_bank_sel2 is the bank select signal for port 3 and flip flop 408 has its default value after power up reset “11”, assigned to memory bank 3.
p0_wr_bank_sel2 initial value is 0 and is continuously rotated to 1, 2, 3, 0, 1, 2, 3, . . .
p1_wr_bank_sel2 initial value is 1 and is continuously rotated to 2, 3, 0, 1, 2, 3, 0, . . .
p2_wr_bank_sel2 initial value is 2 and is continuously rotated to 3, 0, 1, 2, 3, 0, 1, . . .
p3_wr_bank_sel2 initial value is 3 and is continuously rotated to 0, 1, 2, 3, 0, 1, 2, . . .

For example, if p0_wr_bank_sel2=2 at the current clock cycle, port 2 can access memory bank 2 during this clock cycle. Port 2 can access memory bank 3 at the next clock cycle. Port 2 can access memory bank 0 at the third clock cycle.

The bank port select logic 416 comprises 4 D-type flip flops 418, 420, 422, 424 corresponding to bank 0 port select, bank 1 port select, bank 2 port select and bank 3 port select, respectively. The D input to flip flop 418 is coupled to the Q output of flip flop 424. The Q output of flip flop 418 is coupled to the D input of flip flop 420. The Q output of flip flop 420 is coupled to the D input of flip flop 422 and the Q output of flip flop 422 is coupled to the D input of flip flop 424. The clock inputs to the flip flops are coupled to the clock signal 406. The clear on reset inputs CLZ are coupled to the signal resetz on line 404. The signal b0_port_sel2 is the port select signal for memory bank 0 and its default value after power up reset is “00”, assigned to port 0. The signal b1_port_sel2 is the port select signal for memory bank 1 and its default value after power up reset is “01”, assigned to port 1. The signal b2_port_sel2 is the port select signal for memory bank 2 and its default value after power up reset “10” assigned to port 2. The signal b3_port_sel2 is the port select signal for memory bank 3 and its default value after power up reset is “11”, assigned to port 3.
b0_port_sel2 initial value is 0 and is continuously rotated to 3, 2, 1, 0, 3, 2, 1, . . .
b1_port_sel2 initial value is 1 and is continuously rotated to 0, 3, 2, 1, 0, 3, 2, . . .
b2_port_sel2 initial value is 2 and is continuously rotated to 1, 0, 3, 2, 1, 0, 3, . . .
b3_port_sel2 initial value is 3 and is continuously rotated to 2, 1, 0, 3, 2, 1, 0, . . .

The signal b0_port_sel2 is used to select the bank 0 read address source. The signal b1_port_sel2 is used to select the bank 1 read address source. The signal b2_port_sel2 is used to select the bank 2 read address source and the signal b3_port_sel2 is used to select the bank 3 read address source.

The write address logic is generally shown as 490 in FIG. 4. Circuit 490 comprises four identical circuits, one for each port in the system. The first write control logic for port 0 comprises a multiplexer 428 having one input coupled to the initial value of “00” and the other input coupled to the output of adder 426. The control input of the multiplexer 428 is coupled to the signal p0_wr_en and has a 2 bit output coupled to the D input of flip flop 430. The output of flip flop 430 is the signal p0_wr_row_adr2 which is a 2 bit address for the row within one of the memory block, such as 59h, 5Ah or 5Bh. The Q output of the flip flop is also fed back to the input of adder 426 wherein the value is incremented by 1. The signal p0_wr_en is inverted by inverter 432 and output to 1 input of 2 input OR gate 436. The other input the OR gate 436 is the output of AND gate 434 which ANDs the signal p0_wr_en with the signal p0_wr_bank_sel2 equals 3. The output of OR gate 436 is coupled to the enable input of flip flop 430.

In operation, when data is written into the third memory bank of a particular row, it is time to change the row address to access the next row in the data. For example, if data were being written in block 59h on row address 0, once the data 16 is written into the memory bank 3, the row address would be incremented by 1 so that data 17 would be stored on the next row of the block, in memory bank 0.

The circuits for port 1 comprises adder 438, multiplexer 440, D-type flip flop 442, inverter 444, AND gate 446 and OR gate 448. The signals coupled to the input of the inverter and to the second input to the AND gate 446 are those for port 1 instead of port 0. The circuit for port 2 comprises adder 450, multiplexer 452, D-type flip flop 454, inverter 456, AND gate 458 and OR gate 460. The inputs coupled to the input of the inverter and to the second input of the AND gate 458 are for the second port instead of port 0. The circuit for the third port comprises adder 462, multiplexer 464, D-type flip flop 468, inverter 470, AND gate 472 and OR gate 474. The inputs to the inverter and AND gate correspond to those for the third port rather for the port 0. All of the flip flops in all 4 circuits have their clock input connected to the clock signal on line 406.

In the circuit 490, when p0_wr_row_adr2 is a 2 bit port 0 write memory block row address. When the memory write is not enabled, that is, when p0_wr_en is equal to 0, it will clear the circuit address to 0. When p0_wr_en is equal to 1 and p0_wr_bank_sel2 is equal to 3, then signal p0_wr_row_adr2 will be incremented by 1. If the current p0_wr_row_adr2 is 3, it will be equal to 0 after being incremented by 1. p0_wr_en is generated by Port 0. When port 0 has a received TLP data to write to crossbar memory, it set p0_wr_en to 1. This also applied to the three other port write memory block address circuits in the circuits 490.

The blocks 476, 478, 480 and 482 show the generation of the memory write address. For each block, the 7 bit pointer is concatenated with the 2 bit row address discussed above to yield a 9 bit address which is used to address the 512 locations in each memory bank. For example p0_wr_ptr7 is the port 0 write memory block pointer number. It is concatenated with the signal p0_wr_row_adr2 to become the 9 bit port 0 memory write address.

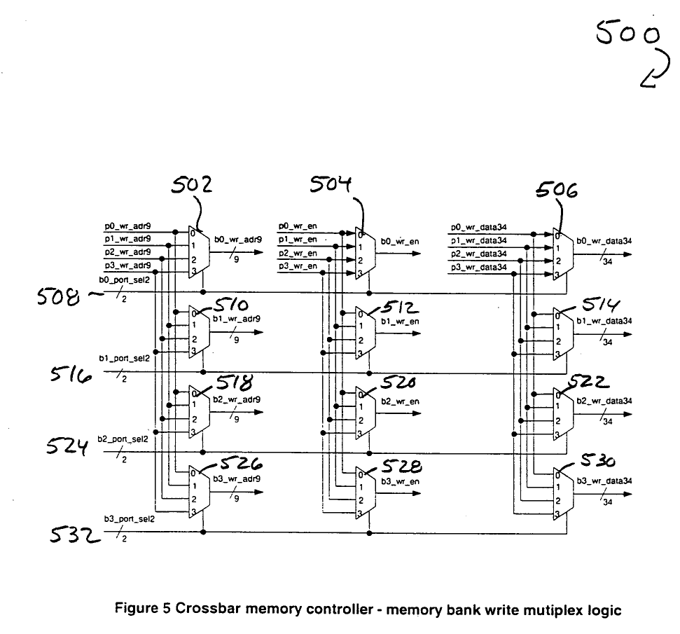

Referring now to FIG. 5, the crossbar memory controller memory bank write multiplex logic is shown generally as 500. The controller 500 comprises twelve 4 input multiplexers 502, 504, 506 . . . 530. Multiplexers 502, 510, 518 and 526 select the 9 bit address to select the location in which data will be written in the crossbar memory. The signals p0_wr_adr9, p1_wr_adr9, p2_wr_adr9 and p3_wr_adr9 are input to the multiplexers 502, 510, 518 and 526. Multiplexer 502 has its select input coupled to the signal b0_port_sel2, multiplexer 510 has its control input coupled to b1_port_sel2, multiplexer 518 has its control input coupled to signal b2_port_sel2 and multiplexer 526 has its control input coupled to b3_port_sel2. The multiplexers generate the 9 bit write addresses for b0_wr_adr9, b1_wr_adr9, b2_wr_adr9 and b3_wr_adr9, respectively.

The multiplexers 504, 512, 520 and 528 generate the write enable signals for the memory banks. The inputs to the multiplexers are p0_wr_en, p1_wr_en, p2_wr_en and p3_wr_en, respectively. The multiplexer 504 has its control input coupled to the signal b0_port_sel2, the multiplexer 512 has its control input coupled to the signal b1_port_sel2, the multiplexer 520 has its control port coupled to the signal b2_port_sel2, and the multiplexer 528 has its control input coupled to the signal b3_port_sel2. Multiplexers 506, 514, 522 and 530 generate the write data signals for the 34 bit data. The multiplexers have their inputs coupled to the signals p0_wr_data34, p1_wr_data34, p2_wr_data34 and p3_wr_data34, respectively. Multiplexer 506 has its control input coupled to the line 508 and signal b0_port_sel2 and has as its output signal the signal b0_wr_data34. Multiplexer 514 has its control input coupled to line 516 and the signal b1_port_sel2 and has as its output signal b1_wr_data34. The multiplexer 522 has its control input coupled to line 524 and the signal b2_port_sel2 and has as its output the signal b2_wr_data34. Multiplexer 530 has its control input coupled to line 532 and the signal b3_port_sel2 and has as its output signal b3_wr_data34. The signal b0_port_sel2 selects the write address, write enable signal and write data for port 0, port 1, port 2 and port 3 memory bank 0 write operation. The signal b1_port_sel2 selects the write address, write enable and write data signals for port 0, port 1, port 2 and port 3 memory bank 1 write operation. The signal b2_port_sel2 selects the write address, write enable and write data port 0, port 1, port 2 and port 3 memory bank 2 write operation. The signal b3_port_sel2 selects the write address, write enable signal and write data for port 0, port 1, port 2 and port 3 from memory bank 3 write operation.

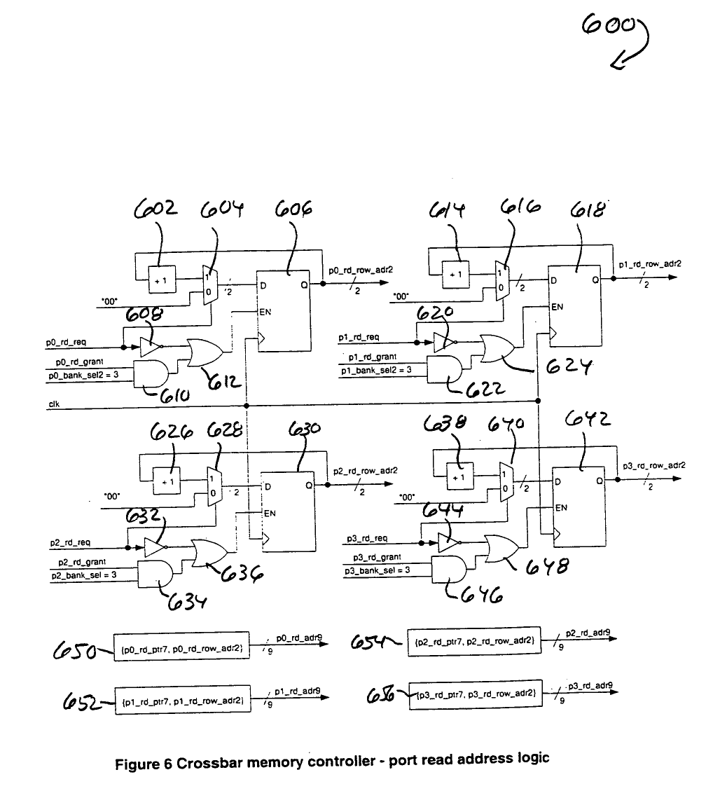

FIG. 6 show the crossbar memory controller port read address logic generally as 600. The port read address logic comprises four identical circuits, one for each port of the switch. These circuits are essentially identical to the circuits 490 in FIG. 4 which generate the port write address signals. A multiplexer 604 has one input coupled to an adder 602 and another input coupled to receive the initial value signal of “00” and has an output coupled to the D input of D-type flip flop 606. The control input to multiplexer 604 is coupled to the signal p0_rd_req which is also coupled to the input of inverter 608. The output of inverter 608 is coupled to one input of a two input OR gate 612, the other input of which is coupled to the output of AND gate 610. The inputs to the AND gate 610 are p0_rd_grant and p0_bank_sel=3. The output of OR gate 612 is coupled to the enable input of flip flop 606. The Q output of flip flop 606 is the signal p0_rd_row_adr2 which is fed back to the input of adder 602. The clock input is coupled to the clock signal clk. P0_bank_sel2 is the same as p0_wr_bank_sel2. P0_wr_bank_sel2 is generated by port write bank select logic 402. Each port has the same bank select number on both read side and write side. P0_rd_req is generated by port 0 to read from crossbar memory for next packet to transmit from port 0. P0_rd_grant is used to grant p0_rd_req read request to access crossbar memory. When p0_rd_grant is 1, port 0 crossbar memory read data will be ready after the next clock rising edge.

The signal p0_rd_row_ard2 is a 2 bit port 0 read memory block row address. When the memory read request signal is not enabled, that is p0_rd_req=0, the signal will be cleared to 0. When the signal p0_rd_req=1, and the signal p0_wr_bank_sel2=3, and the signal p0_rd_grant=1, indicating that memory read access is granted, the signal p0_rd_row_adr2 will be incremented by 1. If the current value of the signal p0_re_row_adr2 is 3, it will be incremented by 1 and become 0.

The circuitry for the ports 1, 2 and 3 are identical to that for port 0. Port 1 has adder 614 coupled to one input of multiplexer 616 which has an output coupled to the D input of D-type flip flop 618 the Q output of D-type flip flop 618 is the signal p1_rd_row_adr2 which is fed back to the input to the adder 614. The second input to multiplexer 616 is the initial value signal of “00”. The control input to buffer 616 is the signal p1_rd_req which is also coupled to the input of inverter 620. An AND gate 622 has first input coupled to p1_rd_grant and a second input coupled to p1_bank_sel2=3. The output of the AND gate is coupled to the second input of 2 input or OR gate 624, the output of which is coupled to the enable input of flip flop 618. The clock for flip flop 618 is coupled to the signal clk. P1_bank_sel2 is the same as p1_wr_bank_sel2. P1_wr_bank_sel2 is generated by port write bank select logic 402. Each port has the same bank select number on both read side and write side. P1_rd_req is generated by port 1 to read from crossbar memory for next packet to transmit from port 1. P1_rd_grant is used to grant p1_rd_req read request to access crossbar memory. When p1_rd_grant is 1, port 1 crossbar memory read data will be ready after the next clock rising edge.

The signal for generation for port 2 comprises adder 626, multiplexer 628, D-type flip flop 630, inverter 632, AND gate 634 and OR gate 636. The input signal to the inverter is p2_rd_req and the inputs to the AND gate are p2_rd_grant and p2_bank_sel=3. The Q output of flip flop 630 generates the signal p2_rd_row_adr2. P2_bank_sel2 is the same as p1_wr_bank_sel2. P2_wr_bank_sel2 is generated by port write bank select logic 402. Each port has the same bank select number on both read side and write side. P2_rd_req is generated by port 2 to read from crossbar memory for next packet to transmit from port 2. P2_rd_grant is used to grant p2_rd_req read request to access crossbar memory. When p2_rd_grant is 1, port 2 crossbar memory read data will be ready after the next clock rising edge. 31 The circuits for port 3 includes adder 638, multiplexer 640 and D-type flip flop 642. The Q output of flip flop 642 is the signal p3_rd_row_adr2 which is fed back to the input of the adder 638. The second input to multiplexer 640 is the initial value signal “00”. The control input to the multiplexer 640 is the signal p3_rd_req which is also to the inverter 644. The inputs to the AND gate are p3_rd_grant and p3_bank_sel=3. P3_bank_sel2 is the same as p3_wr_bank_sel2. P3_wr_bank_sel2 is generated by port write bank select logic 402. Each port has the same bank select number on both read side and write side. P3_rd_req is generated by port 3 to read from crossbar memory for next packet to transmit from port 3. P3_rd_grant is used to grant p3_rd_req read request to access crossbar memory. When p3_rd_grant is 1, port 3 crossbar memory read data will be ready after the next clock rising edge.

Blocks 650, 652, 654 and 656 show the concatenation of the memory block pointer and the 2 bit row address to generate a 9 bit port memory read address. For example, p0_rd_ptr7 is a 7 bit port 0 read memory block pointer number. It is concatenated with p0_rd_row_adr2 to generate the 9 bit port 0 memory read address. This 9 bit address is used to address all 512 locations of each memory bank. This same address logic applied to p1_rd_adr9, p2_rd_adr9 and p3_rd_adr9, which are the port 1, port 2 and port 3 memory read address signals, respectively.

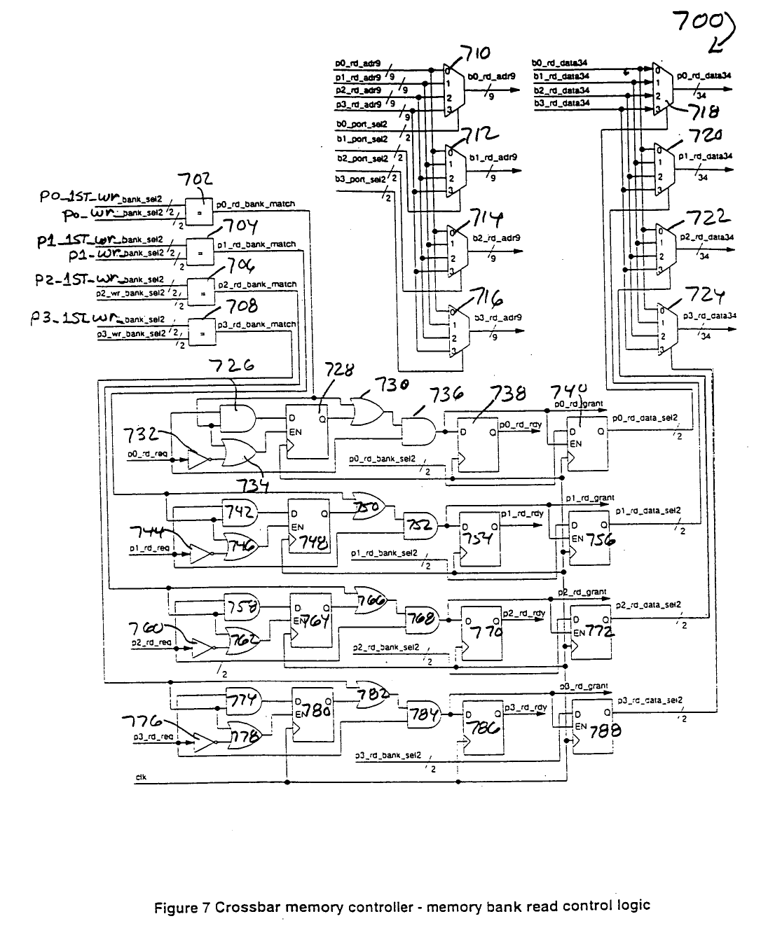

FIG. 7 shows the crossbar memory controller memory read bank control logic generally as 700. Multiplexers 710, 712, 714 and 716 generate the bank 0 read address b0_rd_adr9, the bank one read address b1_rd_adr9, the bank two read address b2_rd_adr9 and the bank three read address b3_rd_adr9, respectively. Each of the multiplexers is coupled to the signals p0_rd adr9, p1_rd_adr9, p2_rd_adr9 and p3_rd_adr9 which are generated in block 650, 652, 654 and 656 of FIG. 6, respectively. The control input to multiplexer 710 is coupled to the signal b0_port_sel2 generated by D-type flip flop 418 in FIG. 4. The control input to multiplexer 712 is coupled to the signal b1_port_sel2 generated by D-type flip flop 420 in FIG. 4. The control input to multiplexer 714 is coupled to the signal b2_port_sel2 generated by the D-type flip flop 422 in FIG. 4 and the control input to multiplexer 716 is coupled to the signal b3_port_sel2 which generated by the D-type flip flop 424 in FIG. 4. Multiplexer 710 generates the signal b0_rd_adr9 which is the bank 0 read address. Multiplexer 712 generates the signal b1_rd_adr9 which is the bank one read address. Multiplexer 714 generates the signal b2_rd_adr9 which is the bank two read address and multiplexer 716 generates the signal b3_rd_adr9 which is the bank three read address. The signal b0_port_sel2 is used as a select signal for the bank 0 read address source. The signal b1_port_sel2 is used as the signal to select the bank 1 read address source. The signal b2_port_sel2 is used as the signal to select the bank 2 read address source and the signal b3_port_sel2 is used as the signal to select the bank 3 read address source.

When the signal b0_port_sel2 is equal to “00”, it selects the signal p0_rd_adr9 as b0_rd_adr9. When the signal b0_port sel2 is equal to “01”, it selects the signal p1_rd_adr9 as b0_rd_adr9. When the signal b0_port_sel2 is equal to “10”, it selects the signal p2_rd_adr9 as b0_rd_adr9. When the signal b0_port_sel2 is equal to “11”, it selects the signal p3_rd_adr9 as b0_rd_adr9. The same logic applies to the signals b1_port_sel2, b2_port_sel2 and b3_port_sel2.

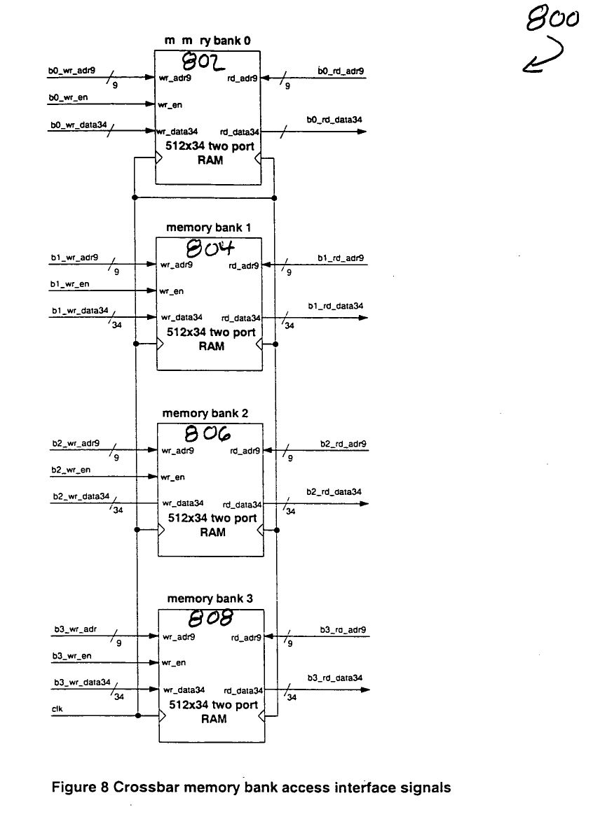

Multiplexer 718, 720, 722 and 724 generate the port 0 read data signal p0_rd_data34, the port one read data signal p1_rd_data34, the port two read data signal p2_rd_data34 and the port three read data signal p3_rd_data34, respectively. Each of the multiplexers has an input coupled to the signals b0_rd_data34, b1_rd_data34, b2_rd_data34 and b3_rd_data34, which are generated by memory bank 0 802, memory bank 1 804, memory bank 2 806 and memory bank 3 808 in FIG. 8. The control input to multiplexer 718 is coupled to the signal p0_rd_data_select2. The control input to multiplexer 720 is coupled to the signal p1_rd_data_select2. The control input to multiplexer 722 is coupled to the signal p2_rd_data_select2. The control input to multiplexer 724 is coupled to the signal p3_rd_data_select2. Each of the control input signals are generated in identical logic which will now be described in detail in connection with multiplexer 718 which is responsive to the signal p0_rd_data_sel2. A comparator 702 receives the signal p0_{—}1^{st}_wr_bank_sel2 generated by _port 0 read request logic and the signal p0_wr_bank_sel2 generated by D-type flip flop 414 in FIG. 4. P0_{—}1^{st}_wr_bank_sel2 is the bank select number when the first double word of the packet is written into crossbar memory from ingress port and this bank select number is transferred to Port 0, so port 0 will follow the packet write sequence to retrieve the packet data. The output of the comparator is the signal p0_rd_bank_match which is coupled to an input of two input AND gate 726, two input OR gate 734 and two input OR gate 730. The other input to AND gate 726 is coupled to receive the signal p0_rd_req which is inverted by inverter 732 and fed as a second input to OR gate 734. The output of AND gate 726 is coupled to the D input of D-type flip flop 728 and the output of OR gate 734 is the enable signal to flip flop 728. The Q output of flip flop 728 is the second input to OR gate 730, the output of which is coupled as one input to a two input AND gate 736. The second input to AND gate 736 is coupled to the signal p0_rd_req. The output of AND gate 736 is coupled to the D input of a second D-type flip flop 738, the Q output of which is the signal p0_rd_rdy. The output of AND gate 736 is the signal p0_rd_grand which is also coupled to the enable input of a third D-type flip flop 740. The D input to flip flop 740 is coupled to the signal p0_wr_bank_sel2. The output of the flip flop 740 is the signal p0_rd_data_sel2 which is coupled to the control input to multiplexer 718. When port 0 start to read from crossbar memory, it assert p0_rd_req to 1 to request read. When p0_{—}1^{st}_wr_bank_sel2 is equal to p0_wr_bank_sel2, p0_rd_grant is set to 1 until p0_rd_req is clear to 0.P0_{—}1^{st}_wr_bank_sel2 is a fixed number, p0_wr_bank_sel2 is port 0 current read or write memory bank select number and it is continuously rotating. P0_rd_grant is used to indicate port 0 crossbar memory read access is granted. P0_rd_rdy is one clock cycle delay from p0_rd_grant which indicates read data is ready in p0_rd_data34. P0_rd_data_sel2 is one clock cycle delay from p0_wr_bank_sel2 which is used to select read data from memory banks. Two port RAM is used for memory bank and it takes one clock cycle to make read data available, so p0_rd_data_sel2 need to be delay one clock cycle from p0_wr_bank_sel2 to match memory bank read data timing.

Similarly, the signals p1_{—}1st_wr_bank_sel2 and p1_wr_bank_sel2 are input to comparator 704 to generate p1_rd_bank_match which is input into AND gate 742 and OR gates 746 and 750. The other input of OR gate 746 is the signal p1_rd_req which is first passed through inverter 744. The output of AND gate 742 is input to the D input of flip flop 748. The enable input to the flip flop is the output of OR gate 746. The Q output of flip flop 748 is input to the second input of two input OR gate 750, the output of which is input into one input of two input AND gate 752. The other input to AND gate 752 is the signal p1_rd_req. The output of AND gate 752 is the signal p1_rd_grant which is input to the D input of flip flop 754 and the enable input of flip flop 756. The output of flip flop 754 is the signal p1_rd_rdy. The D input to flip flop 756 is the signal p1_wr_bank_sel2. The Q output of flip flop 756 is the signal p1_rd_data_sel2 which is input to the control input of multiplexer 720.

The signal p2_{—}1st_wr_bank_sel2 and p2_wr_bank_sel2 are input to comparator 706 to generate p2_rd_bank_match which is input to AND gate 758, and OR gate 762 and 766. The signal p2_rd_req is inverted by inverter 760 and applied to the other input of OR gate 762. The output of AND gate 758 is coupled to the D input of flip flop 764 and the output of OR gate 762 is coupled to the enable input thereof. The Q output of the flip flop 764 is coupled to the other input of two input OR gate 766, the output of which is coupled to one input of AND gate 768. The second input of AND gate 768 is coupled to the signal p2_rd_req. The output of AND gate 768 is the signal p2_rd_grant which is input to the D input of flip flop 770 and the enable input of flip flop 772. The Q output of 770 is the signal p2_rd_rdy. The D input of flip flop 772 is coupled to the signal p2_wr_bank_sel2. The Q output of flip flop 772 is the signal p2_rd_data_sel2 which is coupled to the control input of multiplexer 722.

The signals p3_{—}1st_wr_bank_sel2 and p3_wr_bank_sel2 are coupled to comparator 708 to generate the signal p3_rd_bank_match which is coupled to the input of two input AND gate 774 and two input OR gates 778 and 782. The signal p3_rd_req is inverted by inverter 776 and input into the second input of OR gate 778. The output of AND gate 774 is coupled to the D input of flip flop 780 and the output of OR gate 778 is coupled to the enable input thereof. The Q output of flip flop 780 is coupled to the second input of OR gate 782, the output thereof being coupled to one input of two input AND gate 784. The other input to AND gate 784 is the signal p3_rd_req. The output of AND gate 784 is the signal p3_rd_grant which is coupled to the D input of flip flop 786 and the enable input of flip flop 788. The output of flip flop 786 is the signal p3_rd_rdy. The output of flip flop 788 is the signal p3_rd_data_sel2 which is coupled to the control input of multiplexer 724. All of the flip flops are coupled to the clock signal clk.

The signals p0_wr_bank_sel2 through p3_wr_bank_sel2 are generated by port write bank select logic 402 in FIG. 4 and the signals p0_rd_req are generated by port 0 read request logic when the packet in crossbar memory win arbitration in port 0 and need to read from crossbar memory in order to transmit from port 0.

In operation the signal p0_rd_grant is the port 0 read access granted signal which means that data will be read from one of four memory banks using p0_rd_adr9. When p0_{—}1st_wr_bank_sel2 matches p0_wr_bank_sel2 and p0_rd_req is active, it will set p0_rd_grant to 1 until p0_rd_req is 0. p0_{—}1st_wr_bank_sel2 is the first read port 0 bank select number, which is the same as the first write bank select number from the received port. The same logic applies to the signals p1_rd_grant, p2_rd_grant and p3_rd_grant. The signal p1_rd_grant is the port 1 read access granted signal. The signal p2_rd_grant is the port 2 read access granted signal. The signal p3_rd_grant is the port 3 of the access granted signal.

When the signal p0_rd_grant is set equal to 1, the signal p0_rd_rdy is set to 1 after the next clock rising edge. The signal p0_rd_rdy is used to indicate memory bank 0 read data is ready. The same logic applies to p1_rd_rdy, p2_rd_rdy and p3_rd_rdy.

When the signal p0_rd_grant is set equal to one, the signal p0_wr_bank_sel2, which is the port 0 bank select signal, is copied to p0_rd_data_sel2, which is the port 0 data select signal, after the next clock rising edge. The signal p0_rd_data_sel2 is used to select which memory bank read data will be utilized as p0_rd_data34, which is the port 0 read data signal. When p0_rd data_sel2 is equal to “00”, it selects b0_rd_data34 as the port 0 read data. When the signal p0_rd_data_sel2 is equal “01”, it selects b1_rd_data34 as the port 0 read data. When the signal p0_rd_data_sel2 is equal “10”, it selects the b2_rd_data34 as the port 0 read data. When the signal p0_rd_data_sel2 is equal to “11”, it selects b3_rd_data34 as the port 0 read data. The same logic applies to p1_rd_data34, the port 1 read data; p2_rd_data34, the port 2 read data; and p3_rd_data34, the port 3 read data.

FIG. 8 illustrates the crossbar memory and shows the access interface signals generally as 800. The crossbar memory is made of four banks of memory 802, 804, 806 and 808, each of which is a 512×34 2 port RAM. One port of a 2 port RAM is write only and the other port is read only. Each bank has its separate 9 bit write address signal input to the input wr_adr9 and a 9 bit read address input to rd_adr9. Each also has a write enable signal wr_en a write data signal wr_data34 and a read data signal rd_data34 as well as clock inputs.

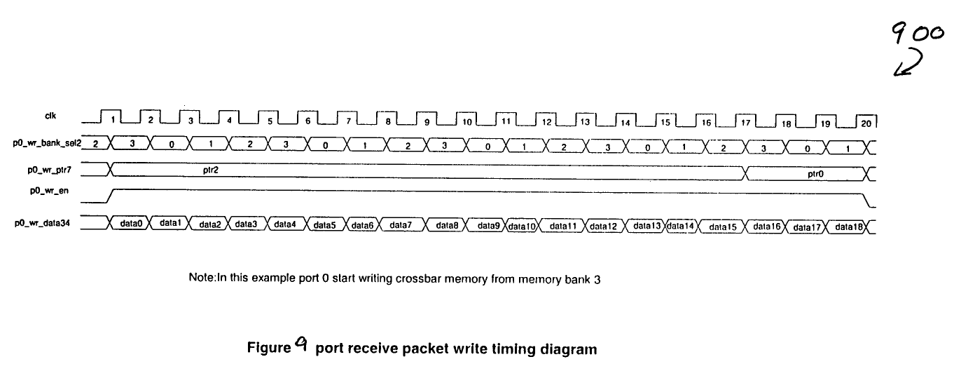

FIG. 9 illustrates the port receive packet write timing diagram generally as 900. The first data, data0, writes to memory bank 3. The 16^{th} data word, data15, is written to the data block pointed by pointer value ptr2 and data15 is written into memory bank 2. The 17th data word, data16, is written to the data block pointed by pointer value ptr0 and data16 is written into memory bank 3. Data 18 is the last data word in the received packet.

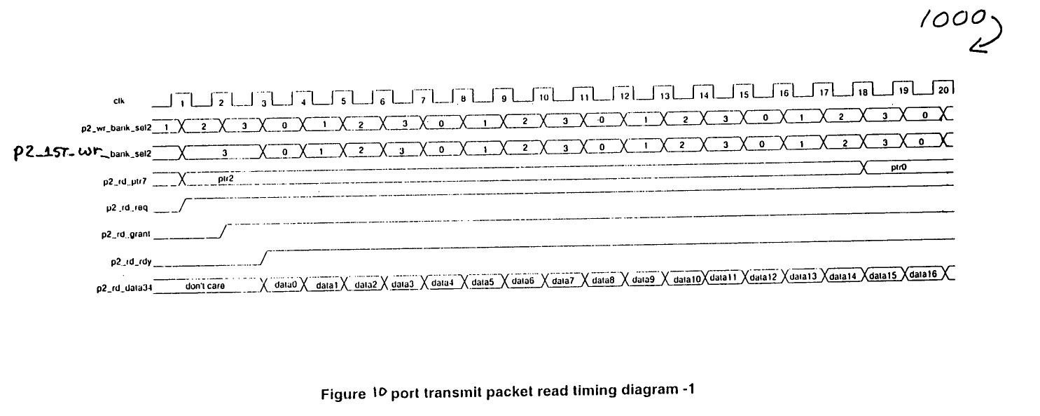

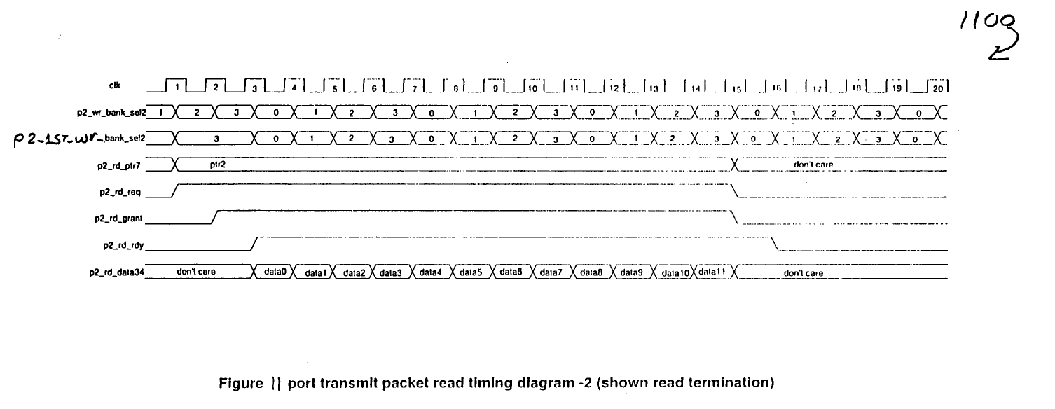

FIG. 10 shows the first port transmit read packet timing diagram generally as 1000 and FIG. 11 shows the port transmit packet read timing diagram 2 generally as 1100. When the signal p2_wr_bank_sel2 is equal to the signal p2_{—}1^{st}_wr_bank_sel2 and the signal p2_rd_req has a value of 1, p2_rd_grant is set equal to 1. After the next clock rising edge p2_rd_rdy is set equal to a value of 1, which indicates that p2_rd_data34 contains the first read data, data0. After the signal p2_rd_grant is active for 16 clock cycles, the read pointer is changed to the next value, ptr0, which will read data from the next data block it will also start reading from memory bank 3 for the first data in the next data block.

In FIG. 11, the crossbar memory read ending timing is illustrated. After the 15^{th} clock rising edge data11 is read and this is the last data in the transmit packet. The signal p2_rd_req, the port 2 read request, and the signal p2_rd_grant, the port 2 read access granted signal, both go to a value of 0. The signal p2_rd_rdy, the port 2 read data ready signal, goes to a value of 0 after the 16^{th} clock rising edge, but the signal p2_rd data34 in the 15^{th} clock cycle is a don't care.

An advantage of the present invention is that a separate “replay memory” is not required. In a PCI Express fabric, packets are transmitted and the system moves on to the next transaction without waiting for an acknowledgement of receipt of the packet. The data in the packet is stored in a replay memory, so that if no acknowledgement is received or an error packet is received, the packet can be retransmitted from the replay memory. In the present invention, the transmitted packet is retained in the crossbar memory and the head pointer is stored. If the transmission terminates normally, the head pointer is sent to the crossbar memory controller to release this portion of the memory. If the transmission terminates abnormally, the head pointer is used to retrieve and resend the packet.

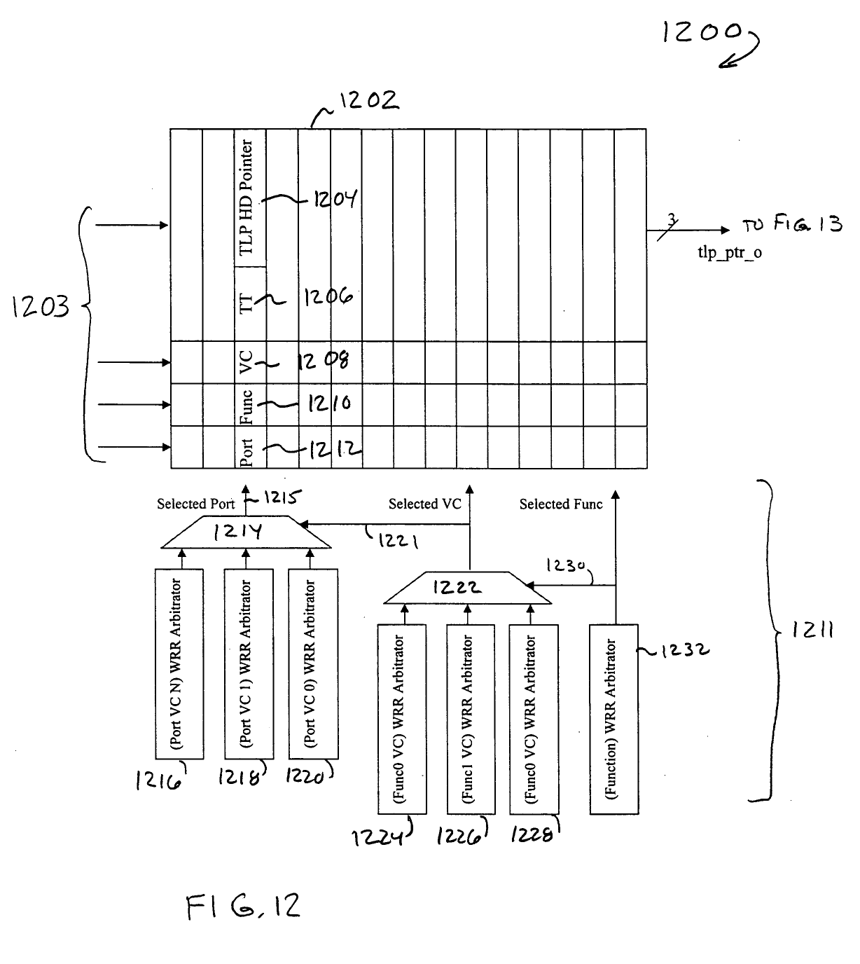

Another advantage of the present system is that the data received at any ingress port is not transferred to the egress port for transmission. All that is transferred it the head pointer and the characteristics of the head pointer for the location where the data is stored. The system for storing the head pointer and head pointed data and for selecting the head pointer for the data to be transmitted is shown in FIG. 12 generally as 1200, which is located on an egress port. The head pointer and its associated data 1203 are entered into the table 1202 from an ingress port on receipt. As shown in FIG. 12, the head pointer is a TLP head pointer which contains a head pointer and 1^{st} write bank select number for one of posted, non-posted and completion transactions which are stored for a particular head pointer at location 1204 in the table. Also stored in this location at 1206 is the transaction type, which is 2 bits to indicate one of the three valid transaction types. Also stored for each pointer is the virtual channel at 1208 which is a virtual channel over which the data will be transmitted, as is well known in the PCI Express fabric. Block 1210 represents the function of the device, where a function will be used for a PCI device which shares the same PCI Express address. Block 1212 represents the port from which the data was from.

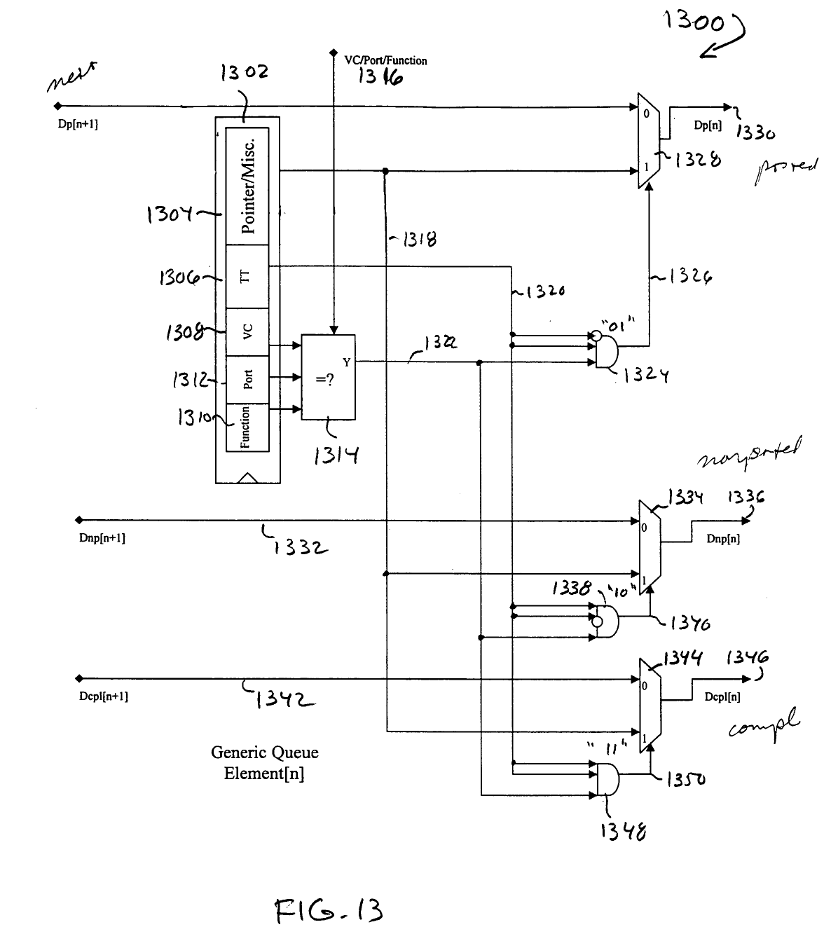

It is now necessary to select the proper head pointer from the table for the transaction that is authorized for a particular egress port. This is accomplished by the circuitry 1211 in FIG. 12. The circuitry comprises arbitrators for this selected port, the selected VC and the selected function. For the selected port, there are N+1 weighted round-robin arbitrators 1216, 1218 and 1220 for port VCN, port VC1 and port VC0 which are fed into multiplexer 1214. The weighted round-robin arbitrators can be the arbitrator in co-pending application Ser. No. ______ entitled “A Weighted-Round Robin Arbitrator” (TI-36016) filed on even date and incorporated herein by reference. The circuit also includes three weighted round-robin arbitrators for the functions 01 and 0, 1224, 1226, 1228. These are input to multiplexer 1222. The circuits include a function weighted round-robin arbitrator 1232 having an output on line 1230 which selects the appropriate function from multiplexer 1222 which outputs the selected VC on line 12 21. The selected VC is also inputted into multiplexer 1214 to output the selected port on line 1215. These three outputs, the selected port, the selected VC and the selected function and the three tip pointers are inputs to the circuits shown in FIG. 13 generally as 1300. In FIG. 13, the selected VC is the selected port of the selected function are input on line 1316 to comparator 1314 wherein in element 1302 in the table 1202 has its function, port and VC stored in segments 1308, 1310 and 1312 correspond to the segments 1208, 1210 and 1212. The output of the comparator is then fed into three AND gates 1324, 1340 and 1348. Also fed into the other two inputs of the AND gate is the 2 bit transaction type tt on line 1320. In AND gate 1324, the first bit of the transaction type is inverted so that the AND gate responds to transaction type “01”, in this case, a posted transaction. For AND gate 1338, the second bit of the transaction type is inverted and the AND gate responds to type “10” which is a non-posted transaction type. In the case of AND gate 1348, neither of the bits is inverted, and the AND gate responds to “11”, which is a completion transaction type.

Referring to AND gate 1324 and multiplexer 1328, if the transaction type matches “01”, then the AND gate output on line 1326 will enable multiplexer 1328 and the pointer for posted-type stored in the pointer/miscellaneous section 1304 of element 1302 will be output as Dp [n] on line 1330. If it does not match, then the signal Dp [n+1] which is the pointer from the next element in the table will be output.

Similarly, with respect to the non-posted transaction type, AND gate 1338 will have output on line 1340 which will activate multiplexer 1334 to place the head pointer 1304 on line Dnp [n] on line 1336. If the transaction type does not match, then the pointer from the next element will be used.

Similarly, with regard to the completion transaction type, if the transaction type of pointer/miscellaneous 1304 matches the completion type, AND gate 1348 will have an output on line 1350 which will activate multiplexer 1344 to send the pointer 1304 on the line Dcpl [n] on line 1346. Otherwise, the completion type from the next element will be used.

It should be noted that each of these elements is strung together so that the circuit can scan all of the elements 1302 in the table 1202 and output the first posted pointer, the first non-posted pointer and the first completion pointer stored in the table that matches the other criteria, that is the selected port, the selected VC and the selected function. The port will determine which of the pointers to use, depending upon the transaction type that will take place, which is determined by the number of credits it will receive form the destination port. In this regard, the circuitry is similar to the circuits shown in the above-mentioned co-pending application, which is incorporated herein by reference.

While the invention has been shown and described with reference to preferred embodiments thereof, it is well understood by those skilled in the art that various changes and modifications can be made in the invention without departing from the spirit and scope of the invention as defined by the appended claims.

1. A PCI Express switch comprising
a plurality of ports;
a plurality of port controllers, each controller being coupled to one of the ports;
a local bus coupling the port controllers to a controller subsystem; and
a single crossbar memory coupled to each of the port controllers and the controller subsystem, the crossbar memory serving as a common port or virtual channel memory for each of the port controllers.

2. The switch of claim 1 wherein the crossbar memory is a common port, virtual channel or type memory.

3. The switch of claim 1 wherein capacity of the crossbar memory is no more than the capacity required for the sum total of all port, virtual channel and type memory for each port.

4. The switch of claim 1 wherein each packet stored in the crossbar memory has a head pointer, the packets being moved from one port to another by moving only the head pointer.

5. The switch of claim 1 wherein the crossbar memory is used as the replay memory by storing the head pointer in the port controller.

6. The switch of claim 5 wherein if the switch does not receive an acknowledgement message indicating that a packet has been received correctly, the stored head pointer is used to retrieve the packet from the crossbar memory for resending the packet.

7. The switch of claim 1 wherein a packet is stored in a plurality of blocks in the crosspoint memory, each block except a last block being linked to a next block by a pointer, a plurality of words of the block each containing one bit of the pointer.

8. The switch of claim 1 wherein the crosspoint memory comprises a plurality of blocks, each block having a fixed size.

9. The switch of claim 7 wherein the crosspoint memory comprises a plurality of blocks, each block having a fixed size.

10. The switch of claim 1 wherein the crossbar memory is divided into a plurality of banks, the plurality being equal to the number of ports and virtual ports in the switch.

11. The switch of claim 1 wherein the crossbar memory is divided into a plurality of banks, the product of the plurality and the number of memory ports being equal to the number of ports and virtual ports in the switch.

12. An arbitration circuit for an output port, comprising:
a FIFO queue containing a head pointer and a plurality of characterizing data for each packet received at an input port, the queue forming a look-up table to determine which data will be sent out from the output port;
a plurality of arbitration circuits coupled to the look-up table for selecting the next packet to be sent out corresponding to a preselected characterizing datum.

13. The arbitration circuit of claim 11 wherein the head pointer of the selected packet is utilized to select the packet from a memory.

14. The arbitration circuit of claim 12 wherein the memory is a common memory for a plurality of arbitration circuits.

15. The arbitration circuit of claim 13 wherein the arbitration circuit is the arbitration circuit for one port of a PCI Express switch.

16. The arbitration circuit of claim 14 wherein the common memory is shared by all ports in the PCI Express switch.

17. The arbitration circuit of claim 15 wherein the common memory is a crossbar memory.

18. The switch of claim 16 wherein the crossbar memory is a common port, virtual channel or type memory.

19. The arbitration circuit of claim 14 wherein the PCI Express switch comprises:
a plurality of ports;
a plurality of port controllers, each controller being coupled to one of the ports;
a local bus coupling the port controllers to a controller subsystem; and
a single crossbar memory coupled to each of the port controllers and the controller subsystem, the crossbar memory serving as a common port or virtual channel memory for each of the port controllers.

20. The switch of claim 18 wherein the crossbar memory is a common port, virtual channel or type memory.

21. The switch of claim 18 wherein the crossbar memory is used as the replay memory by storing the head pointer in the port controller.
